(19) United States
(12) Patent Application Publication
(10) Pub. No.: US 2024/0169034 A1
(43) Pub. Date: May 23, 2024

(54) INFORMATION PROCESSING APPARATUS, INFORMATION PROCESSING METHOD AND PROGRAM

(71) Applicant: Nippon Telegraph and Telephone Corporation, Tokyo (JP)

(72) Inventors: Hiroko YABUSHITA, Musashino-shi, Tokyo (JP); Shiro OZAWA, Musashino-shi, Tokyo (JP); Takao KURAHASHI, Musashino-shi, Tokyo (JP)

(21) Appl. No.: 18/283,290

(22) PCT Filed: Mar. 31, 2021
(86) PCT No.: PCT/JP2021/013835

§ 371 Date: Sep. 21, 2023

(51) Int. Cl. G06F 21/10; G06F 21/31

(52) U.S. Cl. CPC G06F 21/1015; G06F 21/31

(57) ABSTRACT

An information processing device includes: an authentication unit configured to authenticate a licensee who has obtained permission to use a digital twin of a party executing a performance; a sensing unit configured to collect sensing data during the performance of the party, identify a physical condition of the party using the sensing data, and estimate and capture emotions of the party based on the physical condition of the party; and an output unit configured to cause the digital twin of the party to explain the emotions of the party in real-time during the performance of the party.

### TECHNICAL FIELD

The present invention relates to an information processing device, an information processing method, and an information processing program.

### BACKGROUND ART

A technology for generating game review sentences describing an outline of a baseball game is known (Non Patent Literature 1). A technology for providing a commentary and analysis of a shogi game between professional players is also known (Non Patent Literatures 2 and 3).

### CITATION LIST

### Non Patent Literature

Non Patent Literature 1: Kudo and three others, “Automatic Generation of Baseball Game Digest by Using Win Probability Added”, Journal of Japan Society of Information and Knowledge, Vol. 29, No. 2, 2019, p. 181-p. 186
Non Patent Literature 2: Kaneko, “Evaluation of Real-time Commentary Generated by Computer Shogi Program”, p. 9-p. 16
Non Patent Literature 3: Oda and another person, “Division of Game Records for Commentary on Shogi Game Records Considering the Transition of the Game”, 2019 Kyushu Joint Conference of the Institute of Electrical Engineers of Japan, 10-2A-06, p. 413-p. 414

### SUMMARY OF INVENTION

### Technical Problem

However, since a party such as a baseball or shogi player is performing (playing the game), they are not capable of doing other things in real time while performing. Accordingly, they say what they felt during the performance later in non-real-time interview, or a third party commentator speculates what the player is feeling in real time and explains as commentary.

The present invention has been made to solve such a problem, and an object is to provide a technology capable of allowing a party to express their emotions and thoughts in real time during a performance as if they were talking about it themselves.

### Solution to Problem

An information processing device according to one aspect of the present invention includes: an authentication unit configured to authenticate a licensee who has obtained permission to use a digital twin of a party executing a performance; a sensing unit configured to collect sensing data during the performance of the party, identify a physical condition of the party using the sensing data, and estimate and capture emotions of the party based on the physical condition of the party; and an output unit configured to cause the digital twin of the party to explain the emotions of the party in real-time during the performance of the party.

An information processing method according to one aspect of the present invention is a method executed by an information processing device, the information processing method including: a step of authenticating a licensee who has obtained permission to use a digital twin of a party executing a performance; a step of collecting sensing data during the performance of the party, identifying a physical condition of the party using the sensing data, and estimating and capturing emotions of the party based on the physical condition of the party; and a step of causing the digital twin of the party to explain the emotions of the party in real-time during the performance of the party.

An information processing program according to one aspect of the present invention causes a computer to function as the information processing device described above.

### Advantageous Effects of Invention

According to the present invention, it is possible to provide a technology capable of allowing a party to express their emotions and thoughts in real time during their performance as if they were talking about it themselves.

### BRIEF DESCRIPTION OF DRAWINGS

FIG. 1 is a diagram illustrating an exemplified functional block configuration of an information processing device.

FIG. 2 is a diagram illustrating an example of registration data such as DT data.

FIG. 3 is a diagram illustrating an example of past log data.

FIG. 4 is a diagram illustrating an exemplified processing flow of the information processing device.

FIG. 5 is a diagram illustrating an example of new log data.

FIG. 6 is a diagram illustrating an image for explaining emotions of a party using a DT of the party.

FIG. 7 is a diagram illustrating an exemplified hardware configuration of the information processing device.

### DESCRIPTION OF EMBODIMENTS

Hereinafter, an embodiment of the present invention will be described with reference to the drawings. In the drawings, the same elements are denoted by the same reference signs, and descriptions thereof will be omitted.

[Summary of Invention]

The present invention relates to a digital twin (DT) that describes a party's emotions (including thoughts) on their behalf. In particular, it is an invention in consideration of business contemplated by embodying a person on a virtual world.

The present invention collects sensing data during performance of a party, identifies a physical condition of the party using the sensing data, estimates and captures emotions of the party based on the physical condition of the party, and causes a DT of the party to explain the emotions of the party in real time during the performance of the party. Consequently, even when the party is in a performance, the digitized DT of the party is called without limitations of location and time, and the DT explains the emotions during the performance in real time as if the party was speaking themselves.

[Exemplified Configuration of Information Processing Device]

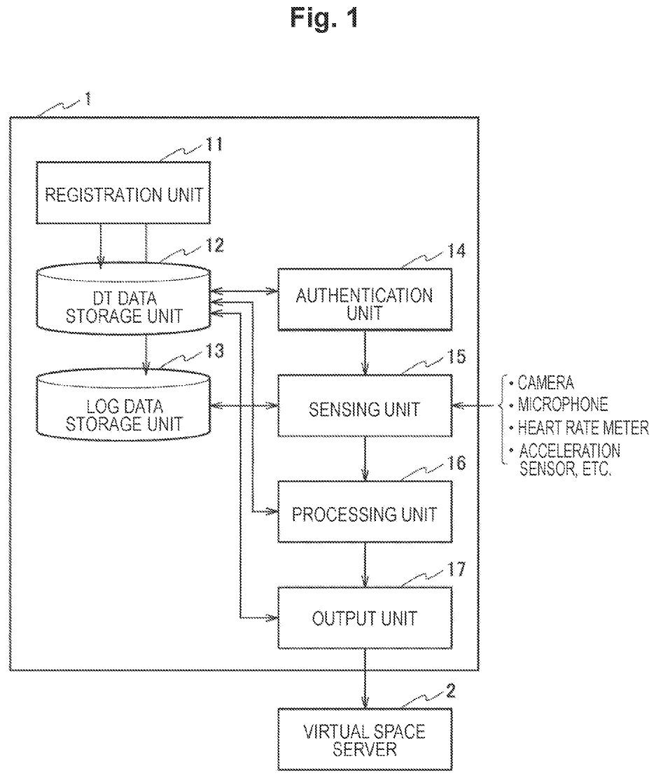

FIG. 1 is a diagram illustrating an exemplified functional block configuration of an information processing device 1 according to the present embodiment. The information processing device 1 is a device, a server, or a computer that causes a DT of a party to explain emotions of the party in real time during performance of the party.

The information processing device 1 according to the present invention is provided with, for example, a registration unit 11, a DT data storage unit 12, a log data storage unit 13, an authentication unit 14, a sensing unit 15, a processing unit 16, and an output unit 17.

The registration unit 11 is a functional unit that creates DT data of the party on the basis of data provided by the party, associates the DT data with a registrant ID, further grants administrator authority to the registrant ID to enable access to the DT data, and registers the DT data in the DT data storage unit 12.

The registration unit 11 is a functional unit that registers the registrant ID and the DT data in the DT data storage unit 12 in further association with a licensee ID for which the party permits the use of the DT data, permitted use of the DT data, and a permitted scope and permitted contents for which the DT data can be used and the emotions can be explained.

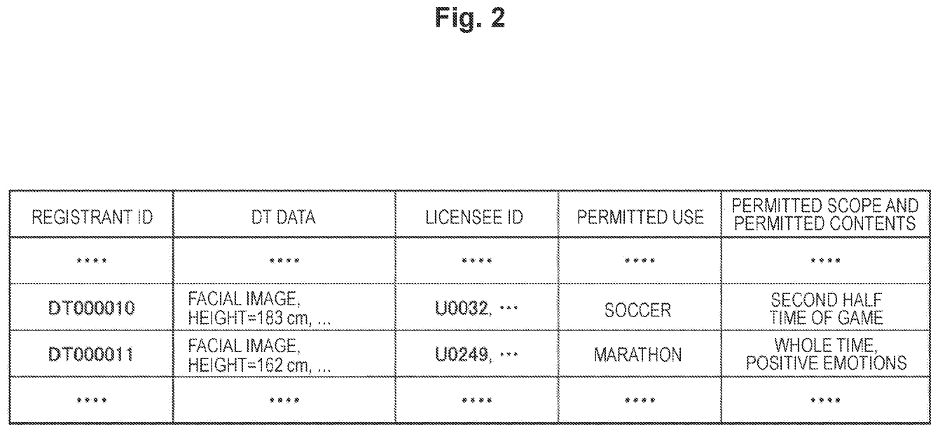

The DT data storage unit 12 is a functional unit that stores registration data such as the DT data registered by the registration unit 11 in a readable manner. For example, as illustrated in FIG. 2, the DT data storage unit 12 stores the registrant ID, the DT data, the licensee ID, the permitted use, and the permitted scope and permitted contents for each registrant. The DT data is, for example, data that is an element for forming DT, such as a facial image, a height, and a voice, and a DT model (for example, CG model, speech synthesis model, action model or interaction model) formed on the basis of the data that is the element for forming DT. The licensee ID is an ID of a licensee who has obtained permission from the registrant to use their DT data. The permitted use is the use of the DT data permitted by the registrant for the licensee. The permitted scope and the permitted contents are respectively a scope and contents of the DT data of the registrant that the licensee has been permitted to use, and are, for example, all or a part of a performance time or positive emotions.

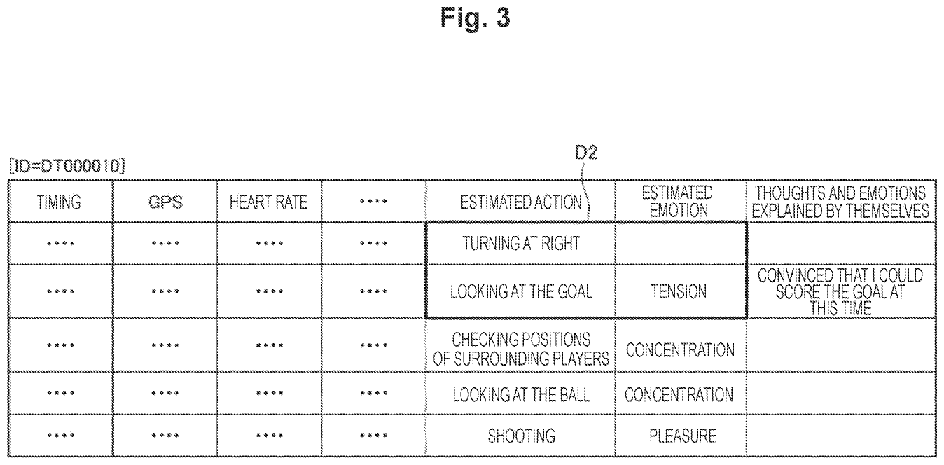

The log data storage unit 13 is a function unit that stores log data collected during the party's past performances in association with the registrant ID of the party. For example, as illustrated in FIG. 3, the log data storage unit 13 stores image data, voice data, position data, sensing data such as a heart rate, acceleration, velocity or body temperature, estimated physical condition (action) data and estimated emotion data directly obtained from the sensing data, and thought/emotion data that the party has told in association with each other at each collection or measurement timing.

The authentication unit 14 is a functional unit that authenticates a user (not limited to the party, but including others, such as the licensee who has received the party's permission to use the DT) who uses the information processing device 1 to access the DT data and log data related to the DT data. For example, the authentication unit 14 authenticates whether the user (in this case, the party) matches the digital twin of the user.

Furthermore, the authentication unit 14 is a functional unit that determines whether the permitted use of the DT data by the user who uses the information processing device 1 matches the set permitted use.

The sensing unit 15 is a functional unit that collects sensing data while the party is in a performance with, for example, a camera, identifies current and future physical conditions (actions) of the party using the sensing data, and estimates and captures current and future emotions of the party based on the physical conditions of the party.

Furthermore, the sensing unit 15 is a functional unit that identifies current and future physical conditions of the party using estimated physical condition (action) data and estimated emotion data, both directly obtained from the sensing data, and estimates and captures current and future emotions of the party. That is, the sensing unit 15 estimates the physical condition and the emotions of the party by further using data on action and emotions semantically understood from the sensing data in addition to the sensing data which is raw data.

Furthermore, the sensing unit 15 is a functional unit that estimates and captures current and future physical conditions and current and future emotions of the party using the sensing data or past log data that stores data matching or similar to the estimated physical condition (action) data and the estimated emotion data, both directly obtained from the sensing data. In this case, the sensing unit 15 may estimate the emotions from the physical condition from the past log data, may predict the physical condition from the emotions, or may simultaneously predict and estimate the physical condition and the emotions.

Furthermore, the sensing unit 15 is a functional unit that identifies current and future physical conditions of the party based on a temporal change in time-varying data stored as the past log data, and estimates and captures current and future emotions of the party. The past log data is, for example, past log data of the party or past log data of someone other than the party.

The processing unit 16 is a functional unit that performs processing (expression change processing) such as conversion, processing, operation, editing and deletion on the current and future emotions of the party, estimated and captured by the sensing unit 15, within the permitted scope and the permitted contents set by the party.

The output unit 17 is a functional unit that reads the DT data of the party from the DT data storage unit 12, outputs the DT data and the current and future emotions of the party subject to the processing to a virtual space server 2, and causes the DT of the party to explain the emotions subject to the processing in real time during the performance of the party.

[Operation Example of Information Processing Device]

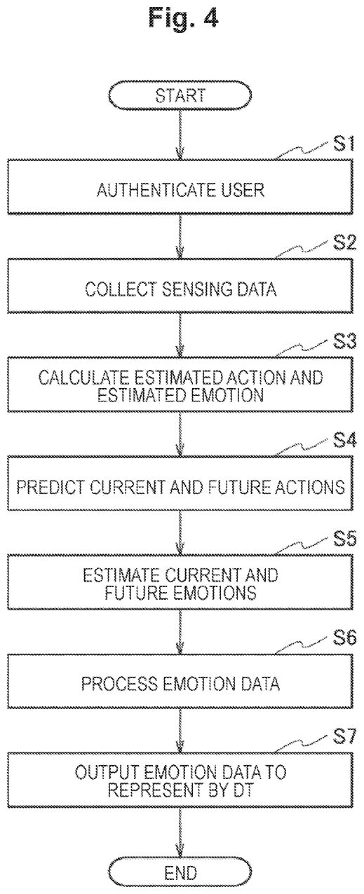

FIG. 4 is a diagram illustrating an exemplified processing flow of the information processing device 1. The registration data illustrated in FIG. 2 is set in the DT data storage unit 12. The past log data illustrated in FIG. 3 is set in the log data storage unit 13.

Step S1;

The authentication unit 14 authenticates a user who uses the information processing device 1, and further determines whether the permitted use of the DT data by the user matches the set permitted use.

For example, the authentication unit 14 determines whether an ID input by the user matches the registrant ID or the licensee ID in the registration data, and further determines whether the permitted use of the DT data input by the user matches the permitted use in the registration data. In a case where both match, the use of the registration data and the use of the log data are permitted; otherwise, neither is permitted.

For example, the authentication unit 14 determines whether a facial shape in a facial image of the user (in this case, the party who will be in performance) captured by a camera matches a facial image in the DT data, and further determines whether the permitted use of the DT data input by the user matches the permitted use in the registration data. In a case where both match, the use of the registration data and the use of the log data are permitted; otherwise, neither is permitted. In addition to the facial image, the authentication unit 14 may use biometric authentication data such as fingerprint, iris, voiceprint, vein, brushstroke, handwriting, and gait; life/action pattern data such as position information and how to use services; a method of setting an ID/password in advance and determining whether the input entries match the set ID/password; one-time password output by a one-time password generator distributed in advance; or verification SMS or email sent to a telephone number or an email address registered in advance.

Step S2;

The sensing unit 15 collects sensing data on the party who is in performance, and stores the sensing data in new log data of the party.

For example, the sensing unit 15 receives sensing data such as image data, audio data, position data, heart rate, acceleration, velocity, and body temperature of the party from accessory devices, such as a camera that captures an image of the party performing performance, a microphone that collects the voice of the party, a GPS that measures the latitude and longitude of the party, a heart rate meter attached to the wrist of the party, and an acceleration sensor attached to the waistline of the party, and stores the sensing data in the new log data of the party.

Step S3;

Since it is less likely that the sensing data such as acceleration completely matches between the new log data and the past log data in the next step S4, the sensing unit 15 converts the sensing data, which is the raw data, into the action and emotion data directly meant by or directly understood from the sensing data.

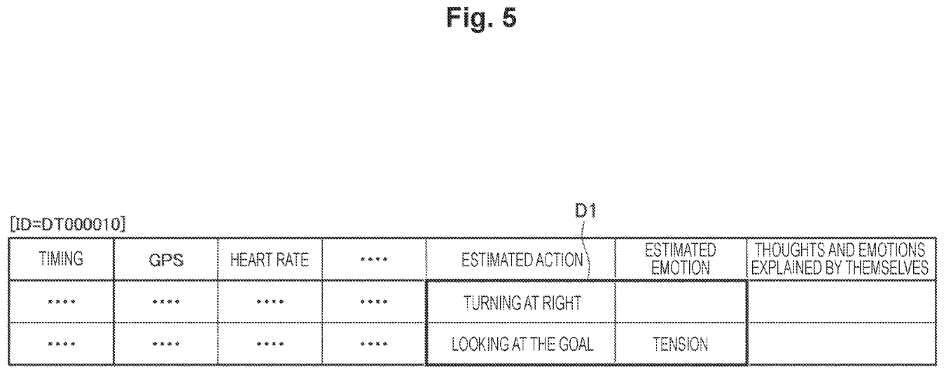

In particular, the sensing unit 15 calculates the current (present close to the latest) estimated action and estimated emotions of the party using the collected sensing data, and adds the current estimated action and estimated emotions to the new log data of the party. An example of the new log data is illustrated in FIG. 5.

For example, in a case where the party is a soccer player, the sensing unit 15 estimates the current action as “looking at the goal at the position of the central area” from the image data and the position data, and estimates that the current emotion is “tension” from the heart rate. Thereafter, the sensing unit 15 stores the current estimated action and the estimated emotions in the estimated action field and the estimated emotion field of the new log data.

For example, in a case where the party is a marathoner, the sensing unit 15 estimates the current action as “17 km/h” from the acceleration, and estimates that the current emotion is “getting tired” from the heart rate. Thereafter, the sensing unit 15 stores the current estimated action and the estimated emotions in the estimated action field and the estimated emotion field of the new log data.

Steps S2 and S3 are periodically performed. The sensing unit 15 stores the sensing data, the estimated action and the estimated emotions at that time in a new record of the new log data in association with a timing, whenever the sensing data is periodically executed.

Step S4;

In steps S4 and S5, the action and emotions of the party are predicted/estimated.

For example, the sensing unit 15 estimates the thoughts of the party at the current timing and what to do next while playing soccer. A situation that cannot be clearly sensed by another device even at the “current timing” is estimated. For example, the sensing unit 15 estimates that the party is “pretending to put the weight on the right foot, preparing with the body balance so that the weight can be shift to the left foot at any time to cope with the next movement”.

Step S4 will be described hereinbelow.

The sensing unit 15 predicts the current and future actions of the party using at least one piece of the new log data (FIG. 5) and the past log data (FIG. 3).

Specifically, the sensing unit 15 compares the new log data of the party with the past log data of the party, and searches for a record of the past log data that matches or is similar to a record near the current timing in the new log data. The sensing unit 15 predicts how the action of the party who is in performance changes immediately after (at present) and slightly after (in the future) from changes in values or contents of the past log data stored after the hit record.

For example, the sensing unit 15 refers to the estimated action and the estimated emotions of the new log data (represented by a frame D1 in FIG. 5), and searches for the past log data having the estimated action and the estimated emotions that respectively match the estimated action and the estimated emotions (represented by a frame D2 in FIG. 3). The sensing unit 15 predicts the current action of the party as “checking the positions of the surrounding players” and predicts the future action of the party as “shooting” from the estimated operation stored after the frame D2 of the past log data.

For example, the sensing unit 15 refers to the acceleration of the new log data, and, in a case where the party was running at “20 km/h” 10 minutes ago, but is currently running at “17 km/h”, extracts an acceleration group having a traveling state similar to the party's traveling state from the past log data of the party. In a case where the party was running at “15 km/h” after 10 minutes in the similar past log data, the sensing unit 15 predicts that the party will run at “15 km/h” after 10 minutes from the current timing.

Various methods other than the above are conceivable as a method of predicting the current and future actions of the party. For example, regarding the current action, the sensing unit 15 may use only the new log data, and use the estimated action stored in the estimated action field of the new log data (current (present close to the latest) estimated action obtained from the sensing data in step S3) as the current action as it is.

In addition to the past log data of the party, the sensing unit 15 can use the past log data of another person whose traits, such as position, physical ability, moving velocity, movement tendency, personality and award history, match or are similar to those of the party, the past log data of another person around the party, and information described in textbooks or special feature articles in the field as references. In this case, the sensing unit 15 predicts the current and future actions of the party from changes in values or contents of the past log data of another person. In a case where there are several pieces of past log data of another person, the sensing unit 15 predicts the current and future actions of the party from average changes in values and contents of the past log data.

Thereafter, the sensing unit 15 adds the predicted current and future actions of the party to the new log data.

Step S5;

The sensing unit 15 estimates the current and future emotions and thoughts of the party using at least one of the new log data (FIG. 5), the past log data (FIG. 3), and the current and future actions of the party predicted in step S4.

For example, the sensing unit 15 estimates the current and future emotions of the party by performing machine learning on, for example, a heart rate, brain waves, facial expression and voice of the party at the current timing and up to now stored in the new log data. For example, in a case where the current heart rate is high and the expression is a straight face, the sensing unit 15 estimates the current emotion as “tension”. For example, in a case where the heart rate from the past to the current tends to increase and the expression changes from a smile to a straight face, the sensing unit 15 estimates a future emotion as “getting tired” after a few minutes.

The current and future emotions and thoughts of the party can also be estimated by a method similar to the method for predicting the current and future actions of the party described in step S4. In particular, the sensing unit 15 can search for past log data of the party that matches or is similar to new log data of the party, and can estimate the current and future emotions of the party during performance from the contents of the past log data stored after the hit record.

For example, the sensing unit 15 estimates, as the current emotion, the estimated emotion of “concentration” corresponding to the estimated action of “checking the positions of the surrounding players” estimated in step S4 from the estimated action and the estimated emotion of the past log data (FIG. 3), and estimates the estimated emotion of “pleasure” corresponding to the estimated action of “shooting” as the future emotion.

Various methods other than the above can be conceivable as a method of estimating the current and future emotions and thoughts of the party. For example, regarding the current emotion, the sensing unit 15 may use only the new log data, and use the estimated emotion stored in the estimated emotion field of the new log data (current (present close to the latest) estimated emotion obtained from the sensing data in step S3) as the current emotion as it is.

Furthermore, the sensing unit 15 may obtain what the party in performance feels and thinks at present and in the future by referring to, for example, (1) information (information stored in a thought/emotion field of the party in FIG. 3) on emotions and thoughts that the party looks back when similar past log data is measured, (2) information on emotions and thoughts that the other person who has performed a similar action looks back, (3) information on a target object and a person ahead of the line of sight of the party, and positional relationship information with the surroundings, and (4) information on rules and patterns obtained from textbooks of sports during performance.

The emotion information may be classified into psychological classifications such as delight, anger, sorrow, and pleasure; 8 major emotions; 46 types of emotions of Ekman; and 48 types of emotions of Spinoza.

Thereafter, the sensing unit 15 adds the estimated current and future emotions/thoughts of the party to the new log data. Information on what the party says by themselves in the past log data may be stored in the estimated emotion field of the new log data as text information. For the emotion when a goal is scored, a time at which the user has scored the goal may be extracted from the sensing data or telecast information, and may be stored in the “explanation as provided, thoughts and emotions” field together with log data such as the sensing data at the time. As a unit of the log, a numerical value of the acquired sensing data may be used as it is, or may be grouped using, for example, machine learning as a semantic unit of the action (“running”, “kicking”, “laughing”).

Step S6;

The processing unit 16 performs processing (expression change processing) such as conversion, processing, operation, editing and deletion on the current and future emotions of the party, estimated and captured, within the permitted scope and the permitted contents set by the party.

Step S7;

Finally, the output unit 17 reads the DT data of the party from the DT data storage unit 12, outputs the DT data itself or a change in shape or voice of the DT data to the virtual space server 2 with the current and future emotions of the party as inputs, and causes the DT of the party to explain the emotions of the party subject to the processing in real time during the performance of the party.

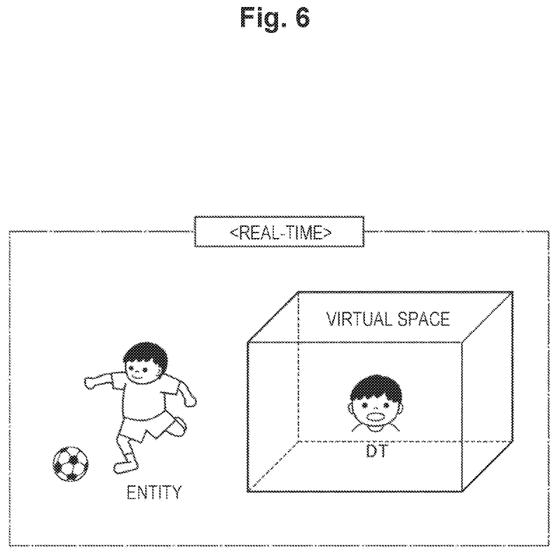

Consequently, for example, the DT of the party, who is a soccer player, can explain the play of themselves in the virtual space or on the television in real time as an interview during a soccer game (see FIG. 6). Additionally, in the virtual space, a party with short life expectancy can simultaneously request a second opinion from doctors at a plurality of clinics and at a plurality of time points, for example, the DT of the party explains their own current mental and physical conditions to the DT of the doctor. The present invention is applicable to various fields such as the Olympics game, go, and shogi.

[Modified Example of Processing Flow]

In the processing flow illustrated in FIG. 4, a case where the emotions are estimated after the motion state is predicted has been described as an example. However, in a case where the motion state and the emotions are predicted/estimated using the past log data, the motion state may be predicted after the emotions are estimated, or the motion state and the emotions may be simultaneously predicted. For example, the sensing unit 15 estimates the current emotion of the party as “concentration” and the future emotion of the party as “pleasure” from the estimated emotions stored after the frame D2 of the past log data illustrated in FIG. 3. Thereafter, the sensing unit 15 predicts the estimated action as “checking positions of surrounding players” corresponding to the estimated emotion of “concentration” as a current action, and predicts the estimated action as “shooting” corresponding to the estimated emotion of “pleasure” as a future action.

[Advantageous Effects]

According to the present embodiment, an information processing device 1 includes: an authentication unit 14 configured to authenticate a licensee who has obtained permission to use a DT of a party executing a performance; a sensing unit 15 configured to collect sensing data during the performance of the party, identify a physical condition of the party using the sensing data, and estimate and capture emotions of the party based on the physical condition of the party; and an output unit 17 configured to cause the digital twin of the party to explain the emotions of the party in real-time during the performance of the party, whereby it is possible to provide a technology capable of allowing the DT of the party to express their emotions and thoughts in real time during their performance as if they were talking about it themselves.

[Others]

The present invention is not limited to the embodiments aforementioned. The present invention can be modified in various manners without departing from the gist of the present invention.

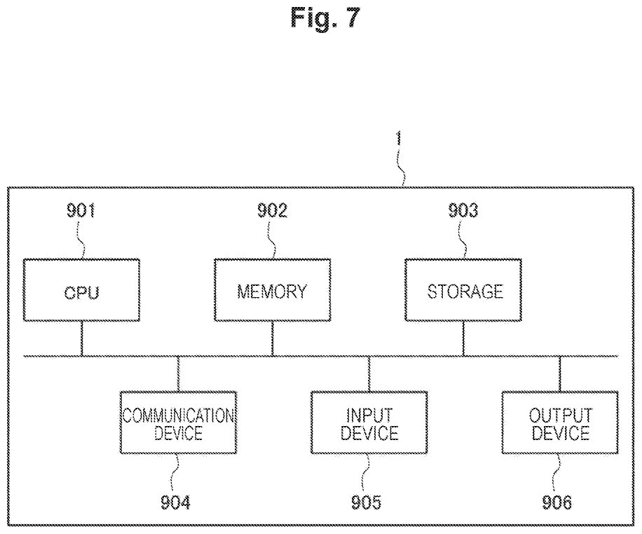

The information processing device 1 of the present embodiment described above can be achieved by using, for example, a general-purpose computer system including a CPU 901, a memory 902, a storage 903, a communication device 904, an input device 905, and an output device 906 as illustrated in FIG. 7. The memory 902 and the storage 903 are storage devices. In the computer system, each function of the information processing device 1 is implemented by the CPU 901 executing a predetermined program loaded on the memory 902.

The information processing device 1 may be implemented by one computer. The information processing device 1 may be implemented by a plurality of computers. The information processing device 1 may be a virtual machine that is implemented in a computer. The program for the information processing device 1 can be stored in a computer-readable recording medium such as an HDD, an SSD, a USB memory, a CD, or a DVD. The program for the information processing device 1 can also be distributed via a communication network.

### REFERENCE SIGNS LIST

1 Information processing device
11 Registration unit
12 DT data storage unit
13 Log data storage unit
14 Authentication unit
15 Sensing unit
16 Processing unit
17 Output unit
2 Virtual space server
901 CPU
902 Memory
903 Storage
904 Communication device
905 Input device
906 Output device

1. An information processing device comprising one or more processors configured to:
authenticate a licensee who has obtained permission to use a digital twin of a party executing a performance;
collect sensing data during the performance of the party, identify a physical condition of the party using the sensing data, and estimate and capture emotions of the party based on the physical condition of the party; and
cause the digital twin of the party to explain the emotions of the party in real-time during the performance of the party.

2. The information processing device according to claim 1, further configured to:
register a scope and contents permitted by the party to the digital twin of the party; and
process the emotions of the party within the permitted scope and contents.

3. The information processing device according to claim 1, configured to identify the physical condition of the party using estimated physical condition data and estimated emotion data, directly estimated from the sensing data, thereby estimating and capturing the emotions of the party.

4. The information processing device according to claim 3, configured to estimate and capture the physical condition of the party and the emotions of the party using past log data which stores data matching the sensing data, or the estimated physical condition data and the estimated emotion data.

5. The information processing device according to claim 4, configured to identify a future physical condition of the party based on a temporal change in time-varying data stored as the past log data.

6. The information processing device according to claim 4, wherein
the past log data
is past log data of someone other than the party.

7. An information processing method executed by an information processing device, the information processing method comprising:
authenticating a licensee who has obtained permission to use a digital twin of a party executing a performance;
collecting sensing data during the performance of the party, identifying a physical condition of the party using the sensing data, and estimating and capturing emotions of the party based on the physical condition of the party; and
causing the digital twin of the party to explain the emotions of the party in real-time during the performance of the party.

8. A non-transitory computer readable medium storing one or more instructions that cause a computer to execute operations comprising:
authenticating a licensee who has obtained permission to use a digital twin of a party executing a performance;
collecting sensing data during the performance of the party, identifying a physical condition of the party using the sensing data, and estimating and capturing emotions of the party based on the physical condition of the party; and
causing the digital twin of the party to explain the emotions of the party in real-time during the performance of the party.

9. The information processing method according to claim 7, further comprising:
registering a scope and contents permitted by the party to the digital twin of the party; and
processing the emotions of the party within the permitted scope and contents.

10. The information processing method according to claim 7, comprising:
identifying the physical condition of the party using estimated physical condition data and estimated emotion data, directly estimated from the sensing data, thereby estimating and capturing the emotions of the party.

11. The information processing method according to claim 10, comprising:
estimating and capturing the physical condition of the party and the emotions of the party using past log data which stores data matching the sensing data, or the estimated physical condition data and the estimated emotion data.

12. The information processing method according to claim 11, comprising:
identifying a future physical condition of the party based on a temporal change in time-varying data stored as the past log data.

13. The information processing method according to claim 11, wherein the past log data is past log data of someone other than the party.

14. The non-transitory computer readable medium according to claim 8, wherein the operations further comprise:
registering a scope and contents permitted by the party to the digital twin of the party; and
processing the emotions of the party within the permitted scope and contents.

15. The non-transitory computer readable medium according to claim 8, wherein the operations comprise:
identifying the physical condition of the party using estimated physical condition data and estimated emotion data, directly estimated from the sensing data, thereby estimating and capturing the emotions of the party.

16. The non-transitory computer readable medium according to claim 15, wherein the operations comprise:
estimating and capturing the physical condition of the party and the emotions of the party using past log data which stores data matching the sensing data, or the estimated physical condition data and the estimated emotion data.

17. The non-transitory computer readable medium according to claim 16, wherein the operations comprise:
identifying a future physical condition of the party based on a temporal change in time-varying data stored as the past log data.

18. The non-transitory computer readable medium according to claim 16, wherein the past log data is past log data of someone other than the party.
